(19) United States
(12) Patent Application Publication
(10) Pub. No.: US 2017/0192795 A1
(43) Pub. Date: Jul. 6, 2017

(54) Universal Computing Element (UCE) and the Mode of Computing with the Use of UCE

(71) Applicant: Middleware, Inc., Redwood City, CA (US)

(72) Inventor: Oleksandr Vityaz, Dnipropetrovsk (UA)

(21) Appl. No.: 15/077,626

(22) Filed: Mar. 22, 2016

Related U.S. Application Data
(60) Provisional application No. 62/137,079, filed on Mar. 23, 2015.

(51) Int. Cl. G06F 9/44

(52) U.S. Cl. CPC G06F 9/4411

(57) ABSTRACT

Computer-implemented systems and methods enable computer programming and software development using Universal Computing Element (UCE) and computing modes that use UCE's. Software, computer program, source/object/assembly code, firmware or other reconfigurable logic or signal processing instructions include at least one UCE. UCE-configured software programs in general-purpose cloud operating system function according to related or unrelated algorithms, as well as for one and/or more owners. Also such software may run on server or cloud, (private, public, or hybrid,) and/or hardware via firmware, micro-circuit, board, or equivalent functional logic.

### FIELD OF INVENTION

The invention pertains generally to the field of computer-implemented systems and methods, and more particularly to computer programming and software development using Universal Computing Element (UCE) and the mode of computing with the use of UCE.

### BACKGROUND OF INVENTION

Conventional computer-implemented design systems provide software tools which often encounter practical problems in software development, for example, pertaining to customer problems (e.g., too long, expensive, inflexibility, high cost of updates, dependence on the developer, succession/inheritance, etc.,) and developer problems (e.g., modern programming with implicit selection of status resulting in inherent technical problems, too long, succession/inheritance, etc.) Thus, it would be desirable to address such conventional problems to improve computer programming and software development.

### SUMMARY

It is contemplated herein that novel computer-implemented systems and methods generally enable computer programming and software development using Universal Computing Element (UCE) and various computing modes that functionally and/or structurally use of one or more UCE. Hence, inventive advantage is accomplished preferably by implementing or otherwise modifying software, computer program, source/object/assembly code, firmware, hardware state machine, or other reconfigurable logic or signal processing instructions to include at least one UCE.

Optionally, one or more novel aspects of the present invention may be embodied in one or more program arranged, for example, in a general-purpose network or cloud operating system programmably configured to function automatically according to related or unrelated algorithms, as well as for one and/or more owners. Alternately novel aspects may be embodied in software running on server or cloud, (which may be private, public, or hybrid network) and/or hardware via firmware, micro-circuit, board, or equivalent functional logic device or electronic equipment.

### BRIEF DESCRIPTION OF FIGURES

FIG. 1 illustrates representative apparatus diagram for embodying general scheme of main unit elements according to one or more aspect of the present invention.

FIG. 2 illustrates schematic representation of variants of unit connection according to one or more aspect of the present invention.

FIG. 3 illustrates schematic representation of robot motion trajectory (Example 1) according to one or more aspect of the present invention.

FIG. 4 illustrates motion process control flowchart of Example 1 according to one or more aspect of the present invention.

FIG. 5 illustrates organization of computation process using UCE of Example 1 according to one or more aspect of the present invention.

FIG. 6 illustrates schematic representation of robot motion trajectory (Example 2) according to one or more aspect of the present invention.

FIG. 7 illustrates motion process control flowchart of Example 2 according to one or more aspect of the present invention.

FIG. 8 (parts 1 and 2) illustrate organization of computation process using UCE of Example 2 according to one or more aspect of the present invention.

FIG. 9 illustrates schematic representation of organization of delivery of short text message from company to customer (Example 3) according to one or more aspect of the present invention.

FIG. 10 illustrates message sending process control flowchart of Example 3 according to one or more aspect of the present invention.

FIG. 11 (parts 1 and 2) illustrate organization of computation process using UCE of Example 3 according to one or more aspect of the present invention.

FIG. 12 illustrates schematic representation of organization of delivery of short text message from company to customer (Example 4) according to one or more aspect of the present invention.

FIG. 13 (parts 1 and 2) illustrate message sending process control flowchart of Example 4 according to one or more aspect of the present invention.

FIG. 14 (parts 1 and 2) illustrate organization of computation process using UCE of Example 4 according to one or more aspect of the present invention.

### DETAILED DESCRIPTION

It is contemplated generally herein that computer-implemented systems/methods enable computer programming and software development using Universal Computing Element (UCE) whereby computing modes use UCE's, such that software, computer program, source/object/assembly code, firmware or other reconfigurable logic or signal processing instructions include at least one UCE. For example, UCE-configured software programs or functionally equivalent reconfigurable hardware may be implemented programmably in general-purpose cloud operating system function according to related or unrelated algorithms, as well as for one and/or more owners, whereby such software runs on server or cloud, (private, public, or hybrid,) and/or hardware via firmware, micro-circuit, board, or equivalent functional logic.

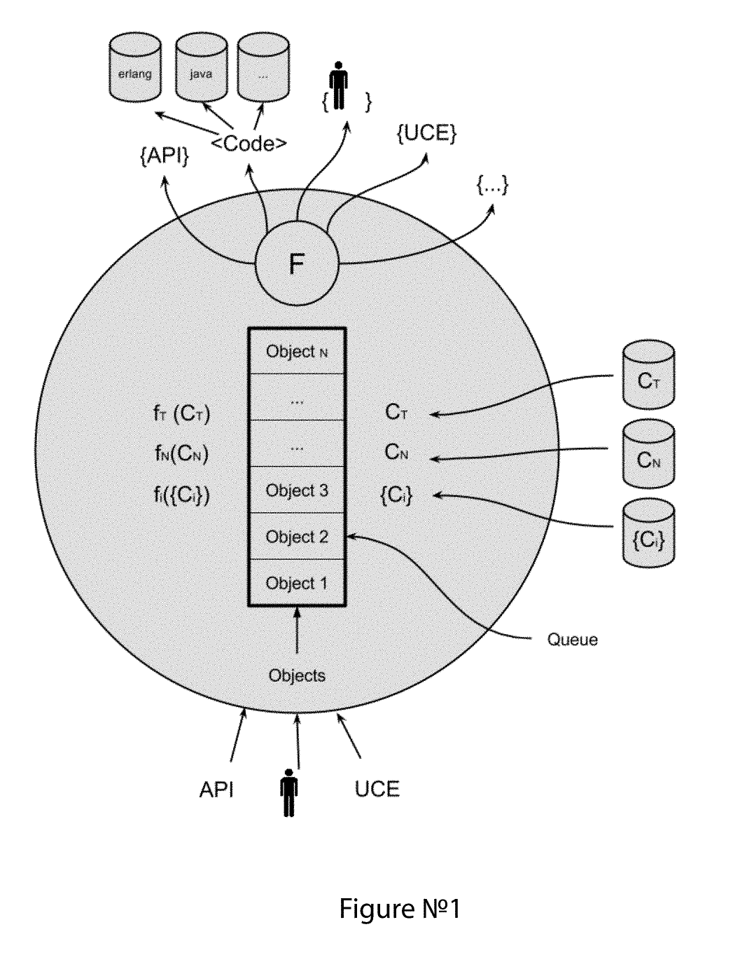

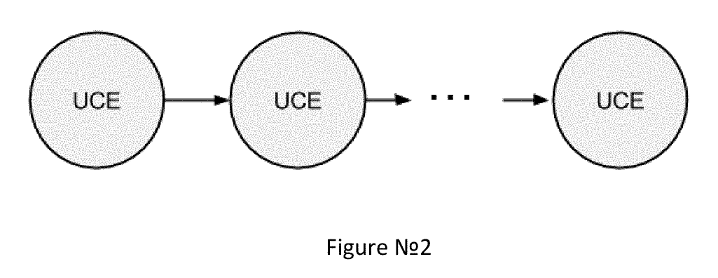

FIG. 1 illustrates representative apparatus diagram for embodying general scheme of main unit elements. Preferably, main unit comprises Universal Computing Elements (UCE), including queue, semaphores, counters, system semaphore T, system semaphore N, as shown in FIG. 1.

As understood herein characteristically, queue pertains to queue of objects in the unit, thereby accepted for computational processing in software, hardware, and/or integrated co-design combination. Semaphores pertain to system and user semaphores, such that when certain values are reached, semaphore triggers parallel process of escalation. Counters pertain to system and user counters, such that counter shows value only, without action; note that this characteristic is how counters differ from semaphores. System semaphore T pertains to specified time of object staying in unit, and system semaphore N pertains to specified number of objects that can be queued in unit.

Other parameters pertain to parameters specifiable for objects queued in the unit. Functions pertain to actions to be performed on the object from the queue in the unit; functions can be in the form of API, software code, other process etc. Thus, it is contemplated that when specified values of semaphores and/or functions are violated (e.g., exceeded,) escalation may be automatically triggered or otherwise arranged with use of process.

Referring further to representative computational system in FIG. 1 as implemented preferably using one or more programmable processor, network-accessible controller, or other computational finite state machine having accessible digital processing facility, storage, and user/network interface(s), “f” pertains to call of function-relevant UCE (i). “F” pertains to function to be realized through operator, API, code, or other UCE being assigned to each unit. “CT” pertains to counter, time T of oldest object in queue. “CN” pertains to number of objects in queue. “{Ci}” pertains to custom counters. “Queue” pertains to FIFO/LIFO queue or objects as inserted/removed by events.

Optionally to optimize performance of large, distributed systems, it may be advantageous to run counters synchronously or asynchronously on separate servers across a network. Generally it is contemplated herein that one or more computational operations are programmable implemented in one or more software application such as source/object/micro-code/firmware, as well as reconfigure-able hardware such as field programmable gate array, programmable logic device, and other configurable electronic logic circuitry, preferably controlled according to one or more processor/server/controller or equivalent construct with network access to one or more other such control construct and any digital memory/electronic memory/storage.

In accordance with one or more embodiment, improved computer programming and software development system and/or automated method uses UCE adaptively in modifiable computing modes, whereupon software, computer program, source/object/assembly code, firmware or other reconfigurable logic or signal processing instructions include at least one UCE, such that UCE-configured software programs may be implemented in general-purpose cloud or network operating system function according to related or unrelated algorithms, as well as for one and/or more owners, whereby UCE-implemented software runs on server or cloud, (private, public, or hybrid,) and/or hardware via firmware, micro-circuit, board, or equivalent functional logic.

Preferably, a representative universal computing element (UCE) unit comprises at least one queue, counter, function from counter (e.g., semaphore) and function applied to queued objects. When computationally defined or otherwise operating, information about one or more object may be automatically transferred to unit queue input (e.g., object identifier—Oi.)

Furthermore, one or more queue is configured and/or described by one or more standard semaphores and/or counters (e.g., semaphore of time/quantity.) Also, one or more rules and/or parameters, data on the object may be processed in the unit, whereby one or more function is applicable to the one or more object. Such application of function to the object may have one or more pre-defined limitations on time and/or quantity.

Moreover, the function can be realized through programmable means such as API, code, process, operator, etc. After successful processing object data, the unit may deliver result for further processing. Upon any deviations from normal operation of the unit (e.g., processing time exceeded; more objects in queue waiting for processing, etc.,) the unit may trigger escalation (e.g., escalation algorithm may include other UCE units). Escalation parameters and conditions can be extended based on needs of certain algorithm(s.)

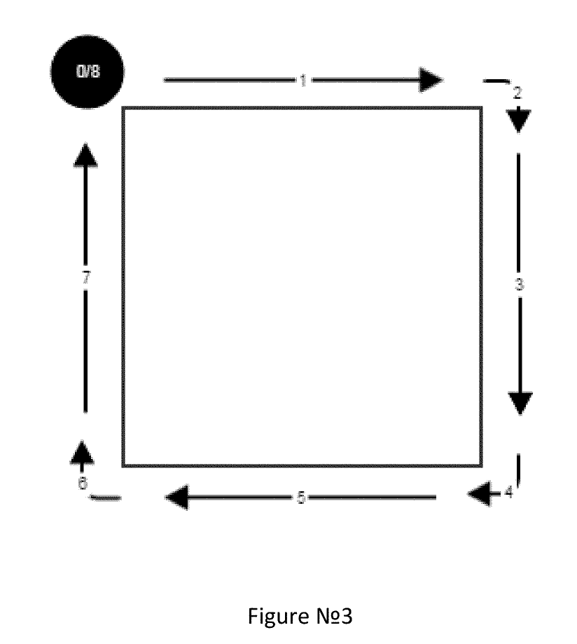

FIG. 2 illustrates schematic representation of variants of multiple UCE unit connection, as possibly coupled in serial and/or parallel network, array and/or subnetwork. Algorithm/process/program can be implemented with the use of the sequence/set/array of UCE, as shown configured in sample implementation of FIG. 2. As understood herein, a process comprises an assembly of units.

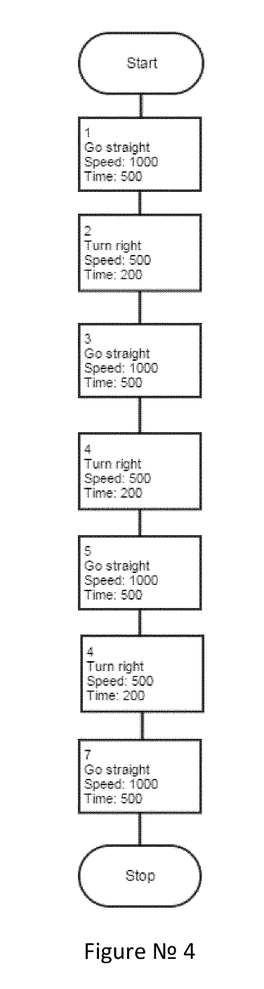

FIG. 3 illustrates schematic representation of Example 1 for robot motion trajectory, particularly implementing automated control of robot vacuum cleaner motion algorithm. Illustrated task organizes robot vacuum cleaner motion computationally along square-shaped trajectory, as shown configured in sample implementation of FIG. 3.

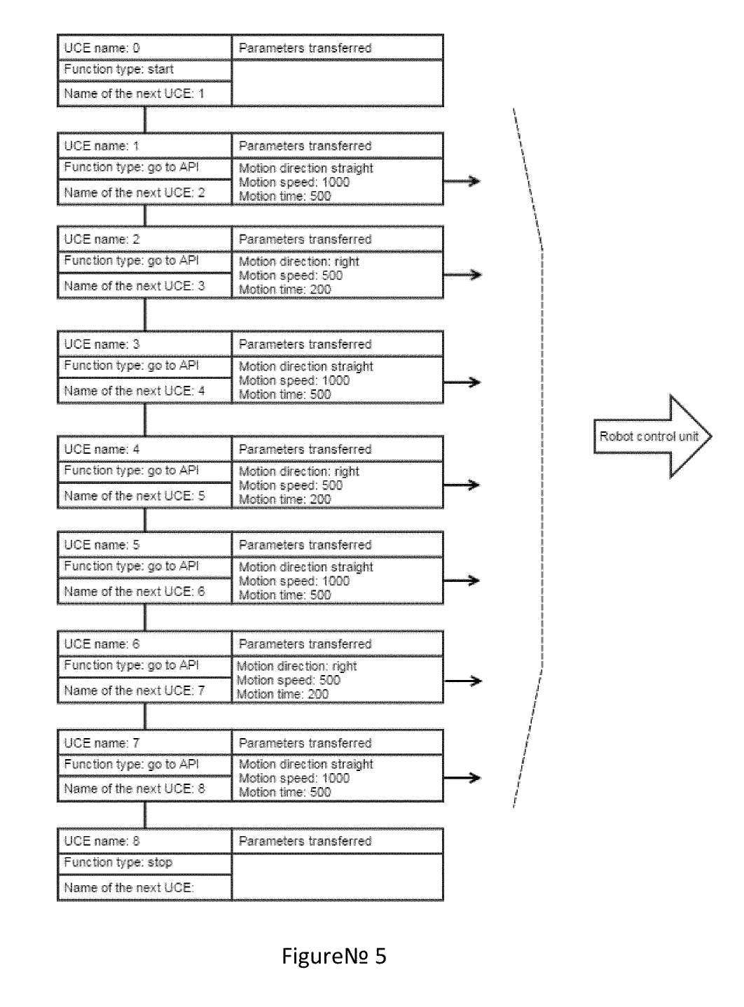

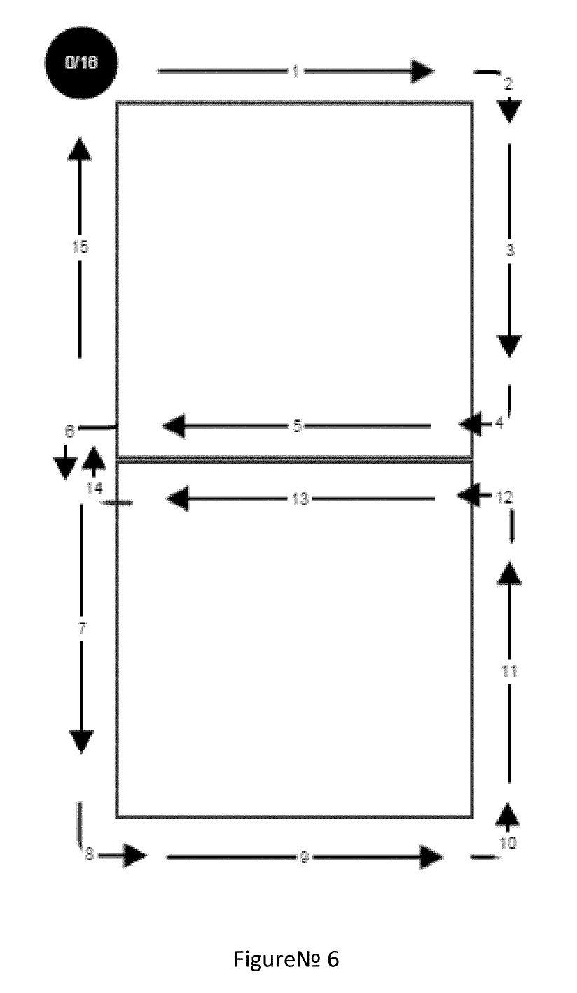

FIG. 4 illustrates motion process control flowchart of Example 1, including various instructions (e.g., go straight, turn right, etc.) with corresponding speed and time values.

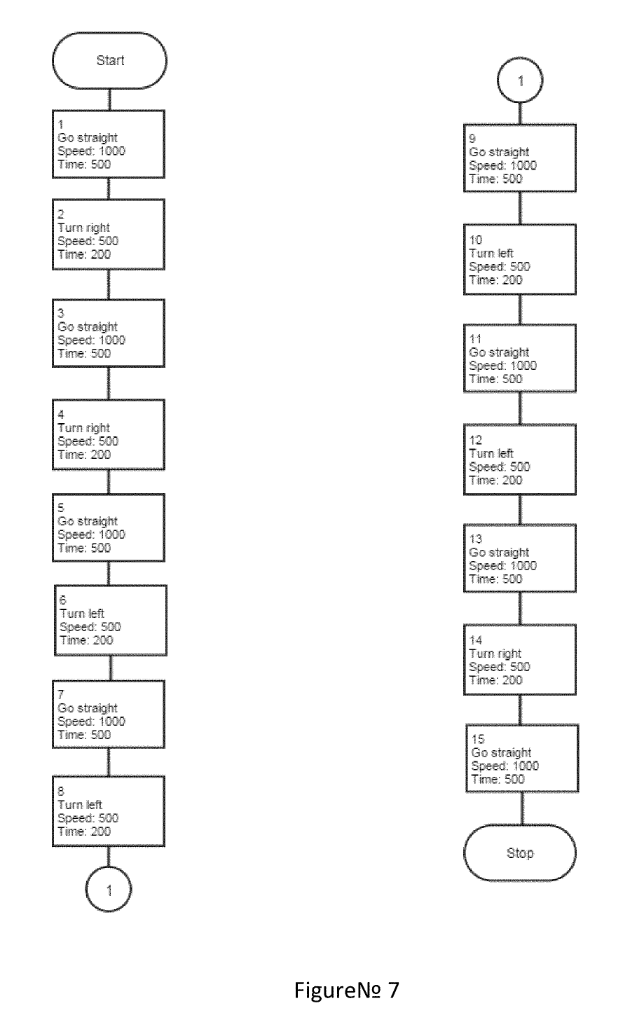

FIG. 5 illustrates organization of computation process using UCE of Example 1. As shown, several programmable settings, e.g., UCE names, parameter transfer, function type, and name of next UCE, etc., are configured for robot control automatically according to such UCE settings.

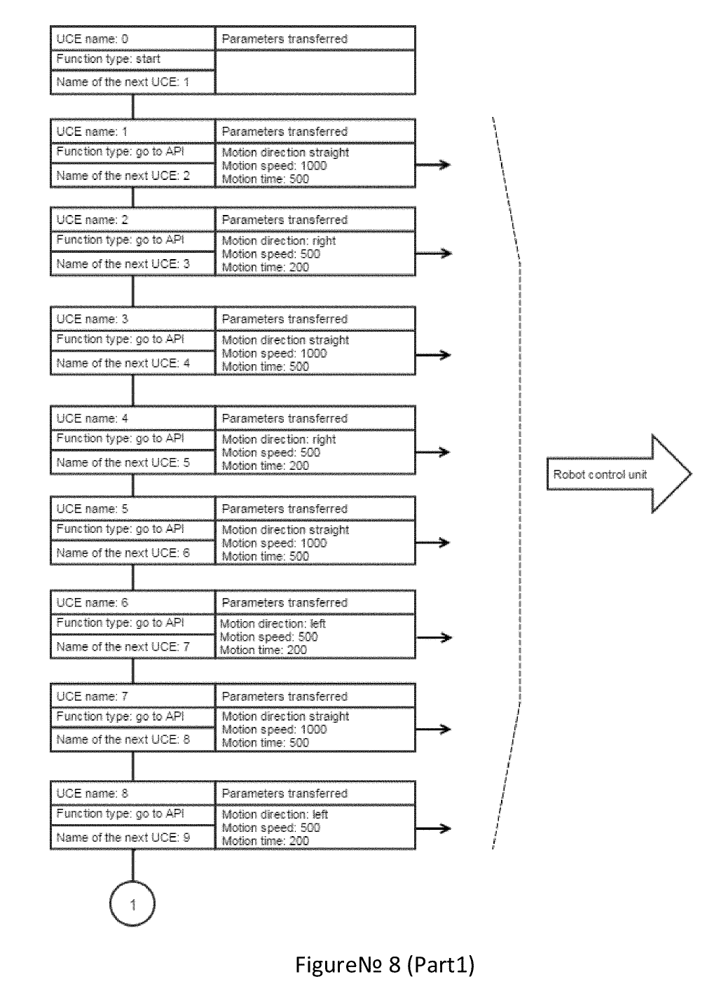

FIG. 6 illustrates schematic representation of another Example 2 for robot motion trajectory that controls robot vacuum cleaner motion algorithm, which organizes robot vacuum cleaner motion along figure-of-eight trajectory, as shown configured in sample implementation of FIG. 6.

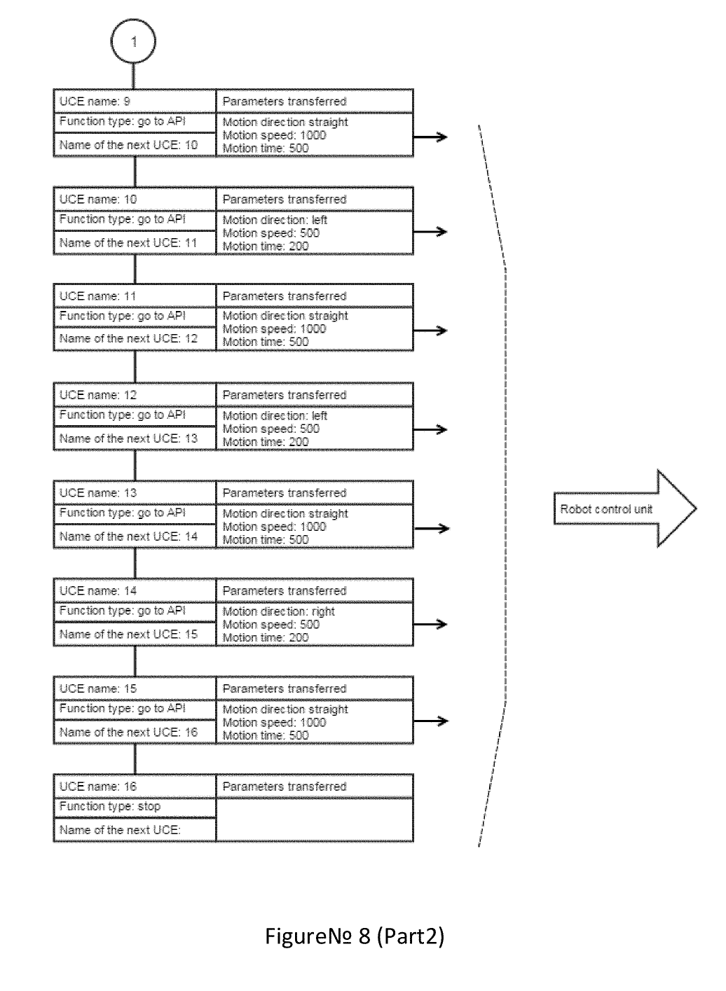

FIG. 7 illustrates motion process control flowchart of Example 2, including various instructions (e.g., go straight, turn right, turn left, etc.) with corresponding speed and time values.

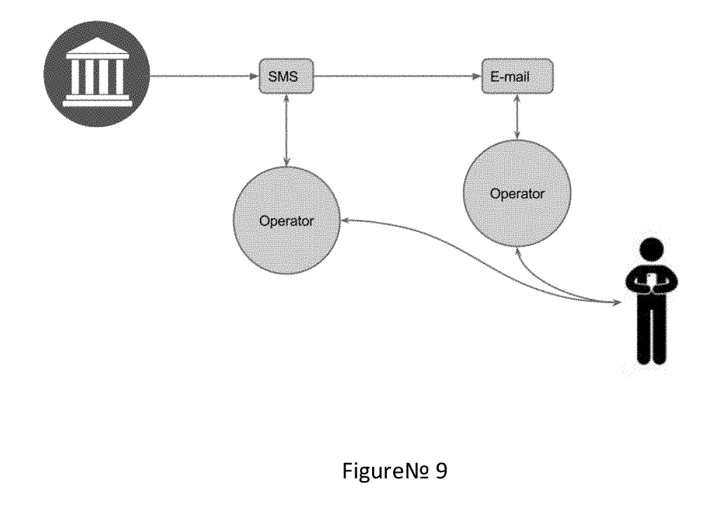

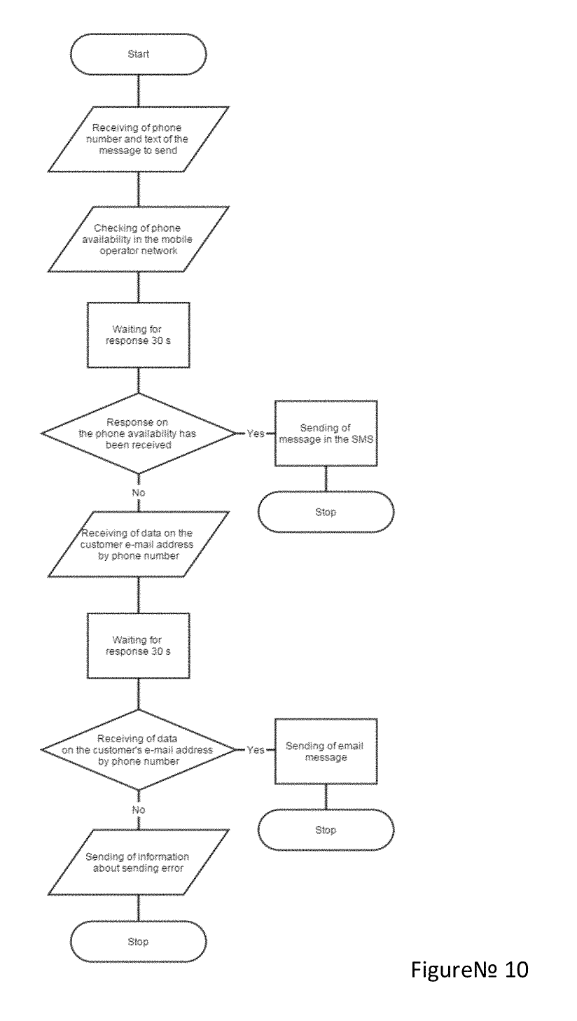

FIG. 8 (parts 1 and 2) illustrate organization of computation process using UCE of Example 2. As shown, several programmable settings, e.g., UCE names, parameter transfer, function type, and name of next UCE, etc., are configured for robot control automatically according to such UCE settings. Note that Example 2 represents more complex variant than the task of Example 1. Yet in comparison of the offered variants to solve tasks using UCE, changing of computational algorithm from FIG. 4 to FIG. 7 advantageously does not require additional programming, because simple changes are relatively easy by using and/or modifying previously used UCE's.

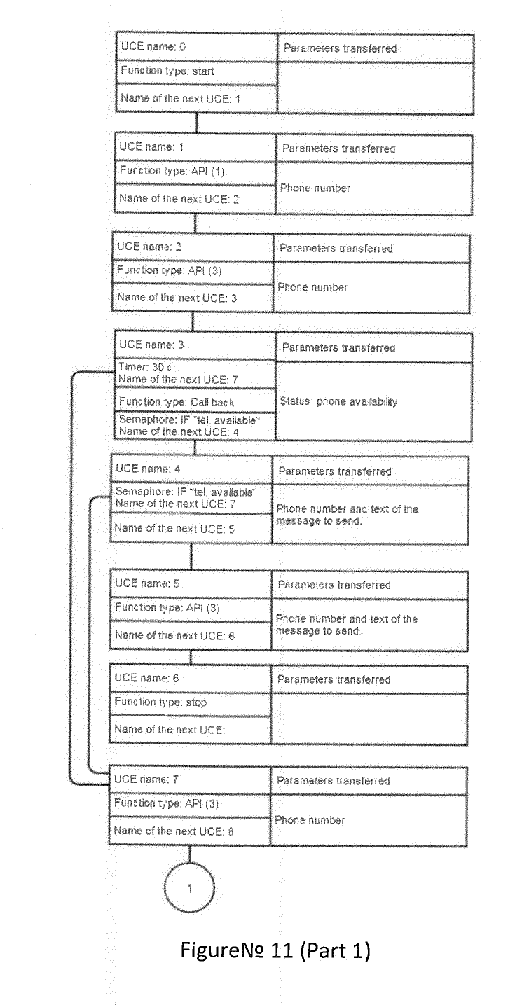

FIG. 9 illustrates schematic representation of organization of delivery of short text and/or email message from company to customer, as Example 3. Accordingly, delivery of short text and/or email message from the company to the customer is organized as shown in FIG. 9, such that control of process of short text and/or email message enables automated sending to a customer with established priority of the message delivery channel, preferably whereby method for sending a message is SMS messaging; but if the message cannot be sent, it may be delivered in e-mail message format.

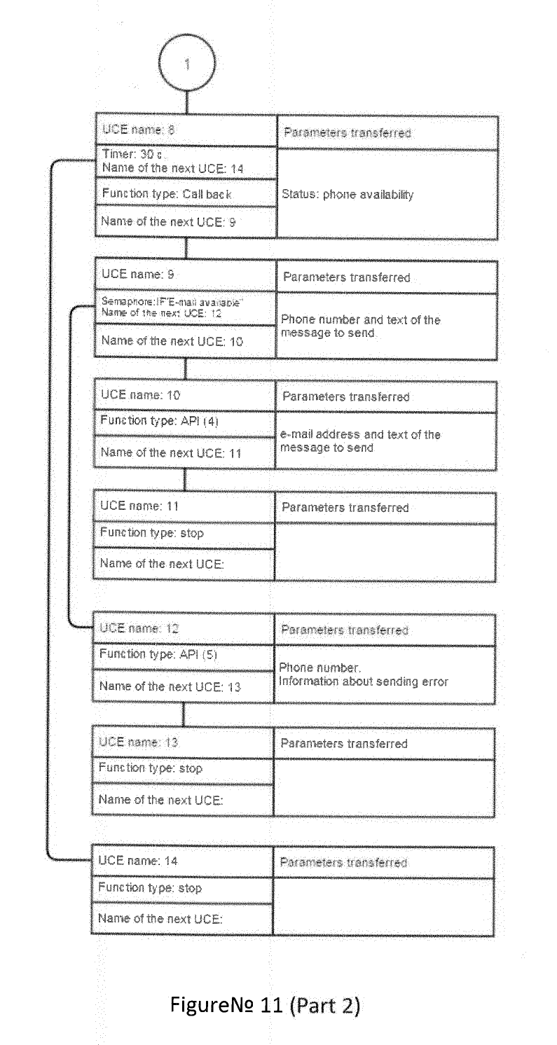

FIG. 10 illustrates message sending process control flowchart of Example 3, including various instructions (e.g., receiving, checking, waiting, responding, sending, etc.)

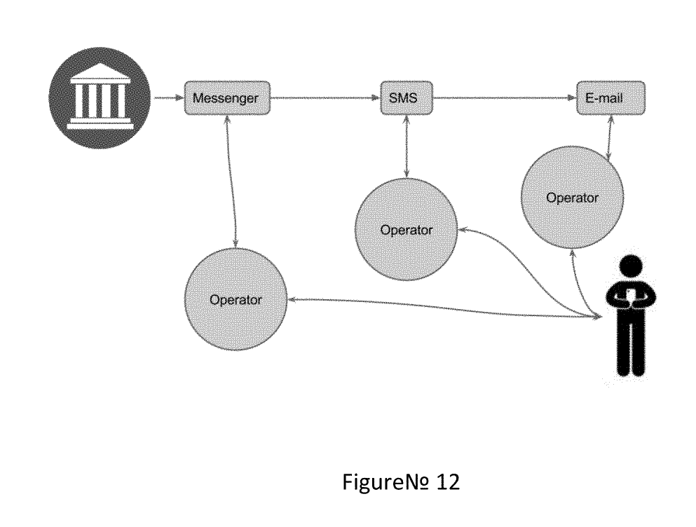

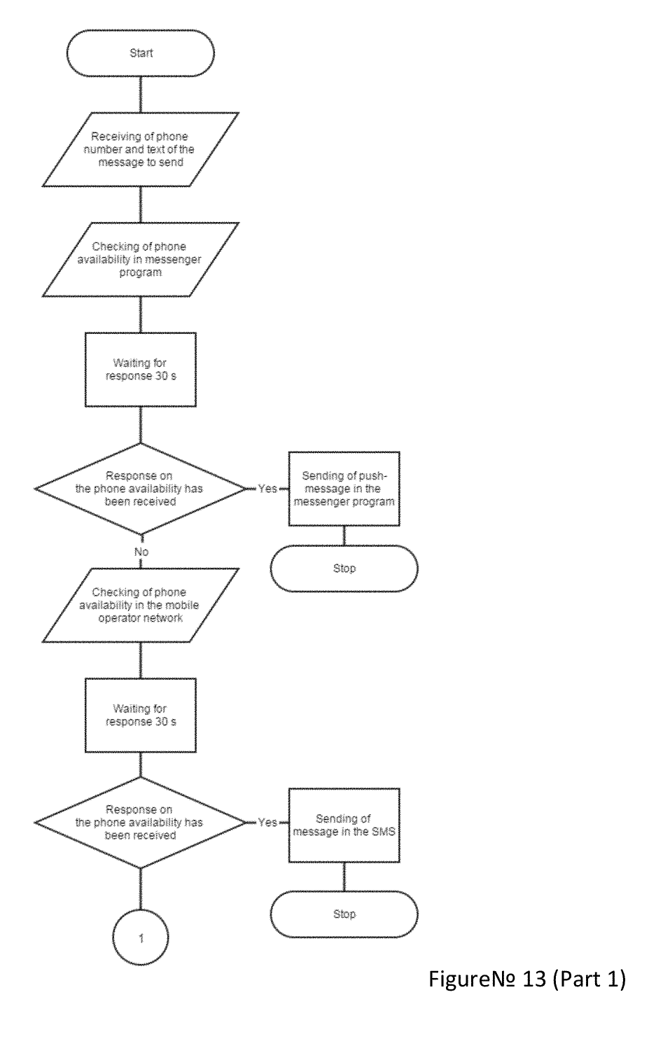

FIG. 11 (parts 1 and 2) illustrate organization of computation process using UCE of Example 3. As shown, several programmable settings, e.g., UCE names, parameter transfer, function type, and name of next UCE, etc., are configured for messaging control automatically according to such UCE settings.

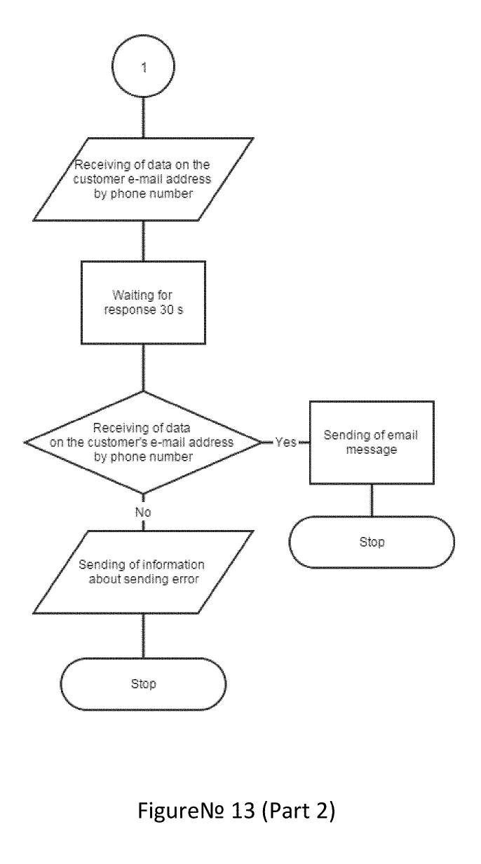

FIG. 12 illustrates schematic representation of organization of delivery of short text message from company to customer, as Example 4. Accordingly, delivery of short text message from the company to the customer is organized as shown in FIG. 12, such that control of process of short text message enables automated sending to a customer with established priority of the message delivery channel, preferably whereby method for sending a message is messaging with the use of messenger and/or e-mail program; but if the message cannot be sent, it may be delivered in SMS, messenger and/or e-mail message format.

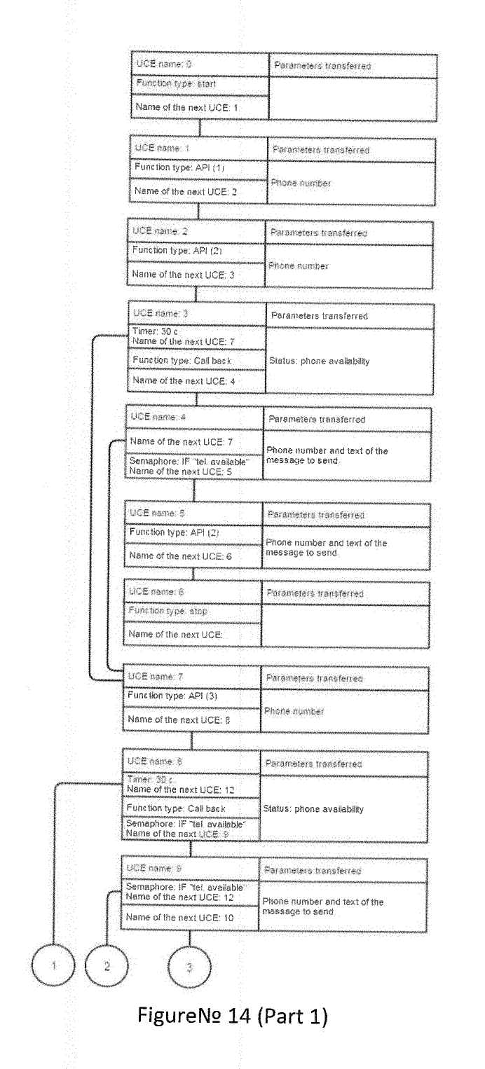

FIG. 13 (parts 1 and 2) illustrate message sending process control flowchart of Example 4, including various instructions (e.g., receiving, checking, waiting, responding, sending, etc.)

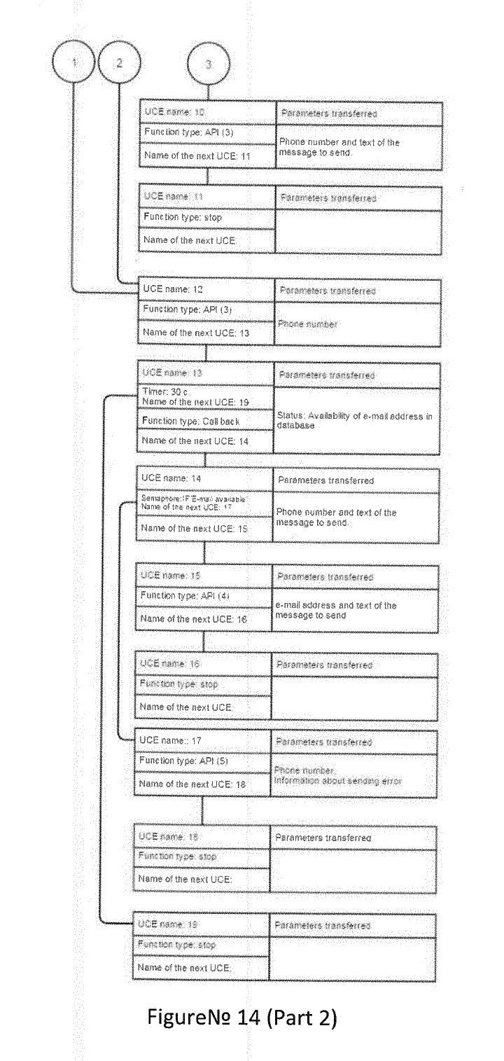

FIG. 14 (parts 1 and 2) illustrate organization of computation process using UCE of Example 4. As shown, several programmable settings, e.g., UCE names, parameter transfer, function type, and name of next UCE, etc., are configured for messaging control automatically according to such UCE settings. Note that Example 4 represents more complex variant than the tasks of previous Examples. Yet in comparison of the offered variants to solve tasks using UCE, changing of computational algorithm from FIG. 10 to FIG. 13 advantageously does not require additional programming, because simple changes are relatively easy by using and/or modifying previously used UCE's. Operationally, this computational algorithm enables automatically sending messages to customers structurally by configuring loading at process start of list of customer phone numbers. UCE counters may record information regarding operations performed in each algorithm branch, thereby reliably confirming upon completion of list processing various attributes or conditions, for example, the number of messages, by which channel and to what customers has been sent, and to whom the messages were not sent since no communication channel was available, etc.

Foregoing descriptions of specific embodiments of the invention have been presented for purposes of illustration and description. They are not intended to be exhaustive or to limit the invention to the precise forms disclosed. Modifications and variations are possible in light of the above teaching. The embodiments were chosen and described in order to explain the principles and the application of the invention, thereby enabling others skilled in the art to utilize the invention in its various embodiments and modifications according to the particular purpose contemplated. The scope of the invention is intended to be defined by the claims appended hereto and their equivalents.

1. Computer-implemented method for enabling computer programming or software development using Universal Computing Element (UCE) comprising steps:
electronically providing a first programmable code application for processing in a computational system; and
electronically configuring the first programmable code application into a second programmable code application comprising at least one Universal Computing Element (UCE), whereby computer programming or software development is facilitated by re-configuring one or more programmable code application comprising such at least one UCE.

2. The method of claim 1 wherein said first or second programmable code application comprises source, object or assembly code.

3. The method of claim 1 wherein said first or second programmable code application comprises hardware, firmware or reconfigurable logic or signal processing circuit comprising at least one UCE.

4. The method of claim 1 wherein said computational system is embodied to function in or with a general-purpose cloud operating system according to related or unrelated algorithms and one or more owners.

5. Computing apparatus for enabling computer programming or software development using Universal Computing Element (UCE) comprising:
means for processing a first programmable code application;
wherein said processing means electronically configures the first programmable code application into a second programmable code application comprising at least one Universal Computing Element (UCE), whereby computer programming or software development is facilitated by re-configuring one or more programmable code application comprising such at least one UCE.

6. The apparatus of claim 5 wherein said first or second programmable code application comprises source, object or assembly code.

7. The apparatus of claim 5 wherein said first or second programmable code application comprises hardware, firmware or reconfigurable logic or signal processing circuit comprising at least one UCE.

8. The apparatus of claim 5 wherein said means for processing is embodied to function in or with a general-purpose cloud operating system according to related or unrelated algorithms and one or more owners.

9. System for programmable computing using Universal Computing Element (UCE) comprising:
a main unit comprising at least one Universal Computing Element (UCE), including at least one queue, semaphore, counter, system semaphore T, and system semaphore N;
whereby computer programming or software development is facilitated by the main unit re-configuring one or more programmable code application comprising said at least one UCE.

10. The system of claim 9 wherein the queue comprises at least one queue of objects in the main unit; the semaphore comprises at least one system or user semaphore, such that when certain values are reached, the semaphore triggers parallel process of escalation; the counter comprises at least one system or user counter, such that the counter shows value only, without action; the semaphore T comprises specified time of object staying in the main unit; and the system semaphore N comprises specified number of objects that can be queued in the main unit.

11. The system of claim 9 wherein the main unit further comprises parameters specifiable for objects queued in the main unit, and functions pertaining to actions to be performed on such objects from the queue in the main unit.

12. The system of claim 9 wherein when specified values of semaphores and/or functions are violated, escalation is automatically triggered or otherwise arranged with use of process.

13. The system of claim 9 wherein the main unit is embodied in at least one programmable processor having accessible storage and user/network interface.

14. The system of claim 13 wherein the main unit is configurable programmably according to “f” call of function-relevant UCE (i), “F” function realizable through operator, API, code, or other UCE, “CT” counter, time T of oldest object in queue, “CN” number of objects in queue, “{Ci}” custom counters, and FIFO/LIFO queue or objects inserted or removed by events.

15. The system of claim 9 wherein the main unit runs a plurality of counters distributedly accessible using separate servers across a network.

16. The system of claim 9 wherein said one or more programmable code application enables robot trajectory control automatically according to said at least one UCE.

17. The system of claim 9 wherein said one or more programmable code application enables message sending control automatically according to said at least one UCE.
